(19) United States
(12) Patent Application Publication
(10) Pub. No.: US 2014/0324519 A1
(43) Pub. Date: Oct. 30, 2014

(54) Operational Risk Decision-Making Framework

(71) Applicant: Bank of America Corporation, Charlotte, NC (US)

(72) Inventors: Pamela R. Dennis, Charlotte, NC (US); Michelle D. Adams, Cornelius, NC (US); Matthew C. Miller, Fort Mill, SC (US); Ken O'Rorke, Saint Petersburg, FL (US)

(73) Assignee: Bank of America Corporation, Charlotte, NC (US)

(21) Appl. No.: 13/949,807

(22) Filed: Jul. 24, 2013

Related U.S. Application Data
(60) Provisional application No. 61/816,093, filed on Apr. 25, 2013.

(51) Int. Cl. G06Q 10/06

(52) U.S. Cl. CPC G06Q 10/0635
USPC 705/7.28

(57) ABSTRACT

A system and method for calculating a quantitative operational risk score and assisting an organization in the risk decision-making process is disclosed. The method may include identifying a plurality of instances of operational risk relevant to the organization to scrutinize, and storing the list of instances of operational risk in computer memory. For each instance of operational risk, the system may provide a rating value for each risk rating input category, and storing the rating values in computer memory. A processor of the system may calculate an operational risk score for each instance of operational risk in the list, and generate/display a risk decision-making matrix/chart. In addition, the system may calculate a portfolio/aggregated operational risk score for each portfolio of related instances of operational risk, and generate/display a risk decision-making matrix/chart accordingly for the portfolio scores.

This application claims priority from U.S. Provisional Application Ser. No. 61/816,093(Attorney Docket No. 007131.01336), filed Apr. 25, 2013, and which is herein incorporated by reference in its entirety.

### RELATED APPLICATIONS

This application is related to commonly assigned U.S. application Ser. No. 13/171,894(Attorney Docket No. 007131.00862), filed Jun. 29, 2011(and published as US2012/0004946 on Jan. 5, 2012) entitled, “Integrated Operational Risk Management,” which claims priority from U.S. Provisional Application Ser. No. 61/60,768(Attorney Docket No. 007131.00830), filed Jul. 1, 2010entitled, “Integrated Operational Risk Platform.” All of the aforementioned applications are herein incorporated by reference in their entirety. Similar to the systems and methods described in U.S. application Ser. No. 13/171,894 (Attorney Docket No. 007131.00862), the systems and methods disclosed herein may assist in providing a probabilistic assessment of a potential realization of specific events taking into consideration any gap in a control environment. For example, U.S. application Ser. No. 13/171,894(Attorney Docket No. 007131.00862) describes, inter alia, risk inputs related to current risks which are also applicable to some of the systems and methods disclosed herein. Meanwhile, the systems and methods disclosed herein improve upon U.S. application Ser. No. 13/171,894(Attorney Docket No. 007131.00862), which teaches a summary of each specific issue and a severity ranking (e.g., see U.S. application Ser. No. 13/171,894, FIG. 3: “Inputs-Risk Issue Summary, Risk Issue Severity”), by, inter alia, providing an enhanced risk issue input capability and an aggregation of similar issue characteristics into a portfolio view. These and other aspects of the disclosure are described and contemplated herein.

This application is related to commonly assigned U.S. application Ser. No. 12/873,921(Attorney Docket No. 007131.00865), filed Sep. 1, 2010(and published as US2012/0053982on Mar. 1, 2012) entitled, “Standardized Technology and Operations Risk Management (STORM).” The aforementioned application is herein incorporated by reference in its entirety.

### BACKGROUND

A risk assessment tool that provides identification, measurement, disposition, monitoring, mitigation, and reporting of known risk items across an information technology (IT) environment is described in U.S. application Ser. No. 12/873,921, which was previously incorporated by reference in its entirety. That U.S. patent application further explains that “Risk management is a process that allows any associate within or outside of a technology and operations domain to balance the operational and economic costs of protective measures while protecting the IT environment and data that supports the mission of an organization. Risk is the net negative impact of the exercise of vulnerability, considering both the probability and the impact of occurrence. However, the risk management process may not be unique to the IT environment; pervading decision-making in all areas of our daily lives. . . . An organization typically has a mission. In this digital era, an organization often uses an automated IT system to process information for better support of the organization's mission. Consequently, risk management plays an important role in protecting an organization's information assets. An effective risk management process is an important component of a successful IT security program. The principal goal of an organization's risk management process should be to protect the organization and its ability to perform the mission, not just its IT assets. . . . The objective of performing risk management is to enable the organization to accomplish its mission(s) (1) by better securing the IT systems that store, process, or transmit organizational information; (2) by enabling management to make well-informed risk management decisions to justify the expenditures that are part of an IT budget; and (3) by assisting management in authorizing (or accrediting) the IT systems on the basis of the supporting documentation resulting from the performance of risk management.”

There are numerous shortcomings in the current state of operational risk decision-making that are overcome by the systems and methods described herein.

### SUMMARY

The following presents a simplified summary of various aspects described herein. This summary is not an extensive overview, and is not intended to identify key or critical elements or to delineate the scope of the claims. The following summary merely presents some concepts in a simplified form as an introductory prelude to the more detailed description provided below.

To overcome limitations in the prior art described above, and to overcome other limitations that will be apparent upon reading and understanding the present specification, aspects described herein are directed towards a method to assist in operational risk decision-making. A system may be configured to execute the method to assist in operational risk decision-making. In one example, the system may comprise at least one computer processor coupled to at least one computer memory; the memory may store a plurality of modules including, but not limited to, an identification module configured to select a plurality of instances of operational risk and store the selections in memory; a rating module configured to receive rating values; a risk score calculation module configured to calculate operational risk scores for individual instances of operational risk and portfolio of risks; a risk decision-making matrix generation module configured to generate a visual representation including the calculated risk scores; a monitor module to monitor particular instances of operational risk from among the instances of operational risk at regular intervals to re-assess the operational risk score; and/or a collaboration module configured to allow more than one rating values to be associated with a single cell in the decision-making matrix, then comparing the more than one rating values to determine a final rating value to be associated with the single cell.

These and additional aspects will be appreciated with the benefit of the disclosures discussed in further detail below.

### BRIEF DESCRIPTION OF DRAWINGS

A more complete understanding of aspects described herein and the advantages thereof may be acquired by referring to the following description in consideration of the accompanying drawings, in which like reference numbers indicate like features, and wherein:

FIG. 1 depicts an illustrative computer system architecture that may be used in accordance with one or more illustrative aspects described herein.

FIG. 2 depicts an illustrative remote-access system architecture that may be used in accordance with one or more illustrative aspects described herein.

FIG. 3 graphically depicts various stages of an illustrative operational risk decision-making process in accordance with one or more illustrative aspects described herein.

FIG. 4 graphically depicts various stages of yet another illustrative operational risk decision-making process in accordance with one or more illustrative aspects described herein.

FIG. 5 depicts a chart/matrix to assist in consistent implementation of an operation risk rating (OOR) methodology in accordance with one or more illustrative aspects described herein.

FIG. 6 graphically depicts some risk input categories and action recommendations for use with an illustrative OOR methodology in accordance with one or more illustrative aspects described herein.

FIG. 7 depicts an illustrative risk decision making matrix for determining which user/users to alert when risk levels are outside predetermined threshold values in accordance with one or more illustrative aspects described herein.

FIG. 8A and FIG. 8B illustrate some instances of operational risk that may together comprise respective portfolios for use in accordance with one or more illustrative aspects described herein.

### DETAILED DESCRIPTION

The management of operational risk in a business or other entity has become increasingly important. For example, in the context of the financial services industry, certain compliance regulations such as Basel II and the Sarbanes-Oxley Act mandate an increased focus on managing operational risk. It has therefore become desirable to increase the effectiveness of operational risk management processes. For example, the effectiveness may be increased through enhanced usability, transparency, and/or consistency of operational risk management processes.

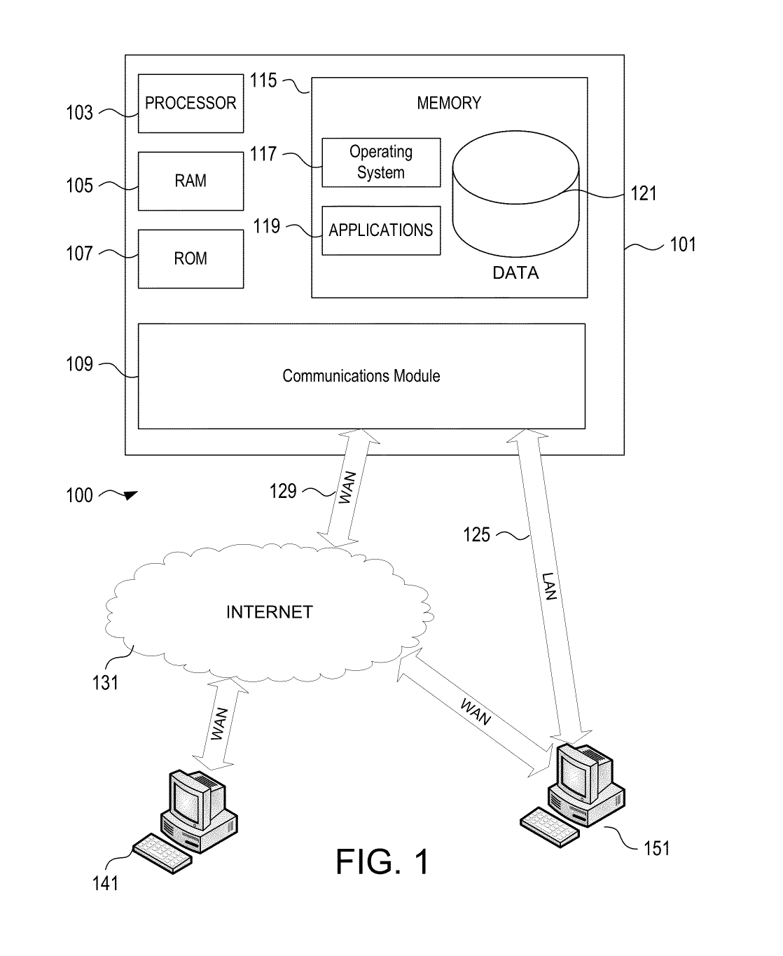

FIG. 1 illustrates an example of a suitable computing environment 100 that may be used according to one or more illustrative embodiments. The computing environment 100 is only one example of a suitable computing environment and is not intended to suggest any limitation as to the scope of use or functionality contained in the disclosure. The computing environment 100 should not be interpreted as having any dependency or requirement relating to any one or combination of components shown in the illustrative computing environment 100.

With reference to FIG. 1, the computing environment 100 may include a computing device/system 101 having a processor 103 for controlling overall operation of the computing device 101 and its associated components, including random-access memory (RAM) 105, read-only memory (ROM) 107, communications module 109, and memory 115. Computing system 101 may include a variety of computer readable media. Computer readable media may be any available media that may be accessed by computing system 101, may be non-transitory, and may include volatile and nonvolatile, removable and non-removable media implemented in any method or technology for storage of information such as computer-readable instructions, object code, data structures, program modules, or other data. Examples of computer readable media may include random access memory (RAM), read only memory (ROM), electronically erasable programmable read only memory (EEPROM), flash memory or other memory technology, CD-ROM, digital versatile disks (DVD) or other optical disk storage, magnetic cassettes, magnetic tape, magnetic disk storage or other magnetic storage devices, or any other medium that can be used to store the desired information and that can be accessed by computing system 101.

Although not required, various aspects described herein may be embodied as a method, a data processing system, or as a computer-readable medium storing computer-executable instructions. For example, a computer-readable medium storing instructions to cause a processor to perform steps of a method in accordance with aspects of the disclosed embodiments is contemplated. For example, aspects of the method steps disclosed herein may be executed on a processor 103 on computing system 101. Such a processor may execute computer-executable instructions stored on a computer-readable medium.

Software may be stored within memory 115 and/or storage to provide instructions to processor 103 for enabling computing system 101 to perform various functions. For example, memory 115 may store software used by the computing system 101, such as an operating system 117, application programs 119, and an associated database 121. Also, some or all of the computer executable instructions for computing system 101 may be embodied in hardware or firmware. Although not shown, RAM 105 may include one or more are applications representing the application data stored in RAM 105 while the computing device is on and corresponding software applications (e.g., software tasks), are running on the computing system 101.

Communications module 109 may include a microphone, keypad, touch screen, and/or stylus through which a user of computing system 101 may provide input, and may also include one or more of a speaker for providing audio output and a video display device for providing textual, audiovisual and/or graphical output. Computing environment 100 may also include optical scanners (not shown). Exemplary usages include scanning and converting paper documents, e.g., correspondence, receipts, and the like to digital files.

Computing system 101 may operate in a networked environment supporting connections to one or more remote computing devices, such as computing devices 141, 151, and 161. The computing devices 141, 151, and 161 may be personal computing devices or servers that include many or all of the elements described above relative to the computing device 101. Computing device 161 may be a mobile device (e.g., smart phone) communicating over wireless carrier channel 171.

The network connections depicted in FIG. 1 may include a local area network (LAN) 125 and a wide area network (WAN) 129, as well as other networks. When used in a LAN networking environment, computing system 101 may be connected to the LAN 825 through a network interface or adapter in the communications module 109. When used in a WAN networking environment, computing system 101 may include a modem in the communications module 109 or other means for establishing communications over the WAN 129, such as the Internet 131 or other type of computer network. It will be appreciated that the network connections shown are illustrative and other means of establishing a communications link between the computing devices may be used. Various well-known protocols such as TCP/IP, Ethernet, FTP, HTTP and the like may be used, and the system can be operated in a client-server configuration to permit a user to retrieve web pages from a web-based server. Any of various conventional web browsers can be used to display and manipulate data on web pages.

The disclosure is operational with numerous other general purpose or special purpose computing system environments or configurations. Examples of well-known computing systems, environments, and/or configurations that may be suitable for use with the disclosed embodiments include, but are not limited to, personal computers (PCs), server computers, hand-held or laptop devices, smart phones, multiprocessor systems, microprocessor-based systems, set top boxes, programmable consumer electronics, network PCs, minicomputers, mainframe computers, distributed computing environments that include any of the above systems or devices, and the like.

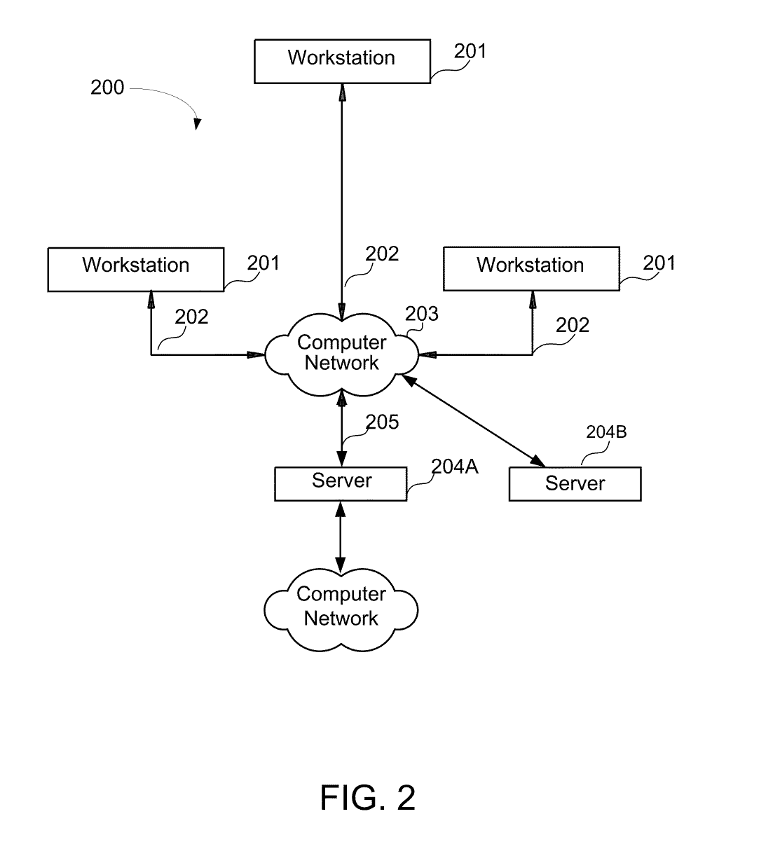

Referring to FIG. 2, an illustrative system 200 for implementing example embodiments according to the present disclosure is shown. As illustrated, system 200 may include one or more workstation computers 201. Workstations 201 may be local or remote, and may be connected by one of communications links 202 to computer network 203 that is linked via communications links 205 to server 204 (e.g., computing system 101). In system 200, server 204 may be any suitable server, processor, computer, or data processing device, or combination of the same. Server 204 may be used to process the instructions received from, and the transactions entered into by, one or more participants.

Computer network 203 may be any suitable computer network including the Internet, an intranet, a wide-area network (WAN), a local-area network (LAN), a wireless network, a digital subscriber line (DSL) network, a frame relay network, an asynchronous transfer mode (ATM) network, a virtual private network (VPN), or any combination of any of the same. Communications links 202 and 205 may be any communications links suitable for communicating between workstations 201 and server 204, such as network links, dial-up links, wireless links, hard-wired links, as well as network types developed in the future, and the like.

A person having ordinary skill in the art after review of the entirety disclosed herein will recognize that there are many different types of operational risk and instances of operational risk factor. Across different industries, the types of operational risk and instances of operational risk factormay significantly differ. For example, some of the operational risks involved in a consumer electronics manufacturing business will differ from those in the aerospace industry. Likewise, the operational risks involved with a financial institution may overlap with some of the operational risks in the aforementioned industries, but will also include other instances of risk irrelevant to those other industries. Governmental regulations and other rules/policies may cause particular instances of risk to be relevant to some industries, but not others. Nevertheless, a person having ordinary skill in the art after review of the entirety disclosed herein will recognize those instances of operational risk relevant to his/her industry, and identify those instances of operational risk for use in the system disclosed herein. For example, in the financial/banking industry, in some embodiment, the system may include an input of 1,700 to 2,000 instances of operational risk. In other embodiments, the number of instances of operational risk may be less than 1,700. In yet other embodiments, the number of instances of operational risk may be more than 2,000. The number and type of operational risks may depend upon the types of products/services offered by the financial institution, and the number of regulations/rules governing these products/services. Some examples of operational risk include, but are not limited to fraud risk, system failure risk, terrorism risk, and other risks.

In addition, other types of operational risks, including, but not limited to forecasted emerging (future) risks, current risks, and/or historical realized risks may be used with the system 101 disclosed herein. For example, emerging risks may be forecasted based on assessed current risks and/or historical realized risks. Current risks may be assessed based on the assessed forecasted emerging risks and/or historical realized risks. Moreover, in some examples, current risk may be further clarified as inherent risks, control risks (e.g., control design or control performance), and/or residual risks. In some cases, operational risks may be further classified based upon causal or other groupings such as those based on regulatory compliance requirements, and/or geographic and organizational source. For example, in some cases operational risks may be further clarified as people risks, process risks, system risks, external risks, and/or compliance risks. Forecasted emerging (future) risks, current risks, and/or historical realized risks are discussed in detail in U.S. application Ser. No. 13/171,894(Attorney Docket No. 007131.00862), which was previously incorporated by reference in its entirety herein.

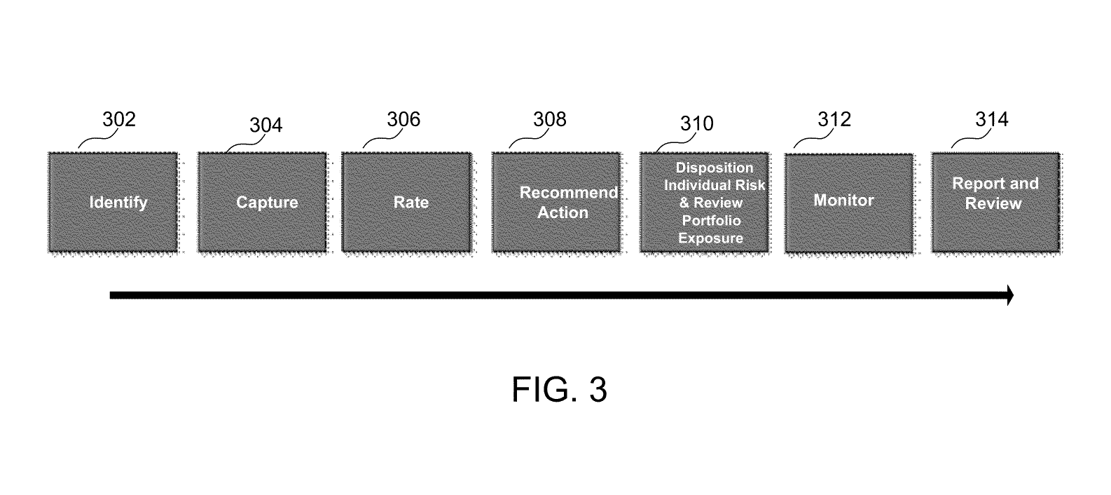

Referring to FIG. 3, during the initial identify 302 and capture 304 stages of the operational risk decision-making process, a self-assessment of risks and controls may be performed. In addition, comprehensive and/or standardized risk and control content (e.g., regulations, rules, and policies) may be captured. As a result, a list of instances of operational risk may be generated and stored in computer memory 115 of the system using techniques well known to a person having ordinary skill in the art. The list of instances of operational risk may comprise just a few instances of risk or may comprise hundreds or thousands of instances of risk, depending on the specific subject matter being analyzed for operational risk. This disclosure contemplates the list of instances of operational risk being generated in one or more of various different ways.

In accordance with the preceding example, in one embodiment the system 101 may generate a list of instances of operational risk based on inputs provided by a user. These inputs may serve as a basis for the system to identify particular categories of instances of operational risk for the operational risk decision-making process. For example, in response to the system's query, the user may indicate that the specific subject matter being analyzed involves intake of a credit card payment from customers. Such a user input may cause the system to automatically add a group of instances of operational risk associated with credit card fraud operational risks (e.g., credit card fraud operational risk category) to the list of instances of operational risk to consider. As a result, the system 101 may compile and store a list of instances of operational risk that will be scrutinized in subsequent stages of the operational risk decision-making process.

In yet another embodiment following in the same vein as the preceding embodiment, the list of instances of operational risk may be manually selected by one or more users using, for example, an identification module. The identification module may be configured to assist users in selecting a plurality of instances of operational risk from a larger list of possible instances of operational risk and (optionally) storing the selections in computer memory. For example, one or more representatives from each department of a multi-department organization may manually select instances of operational risk relevant to their department to add them to the list of instances of operational risk stored in the system. In selecting instances of operational risk, the user/users may use information collected from business functions such as division/department, information collected from business functions such as enterprise control function (ECF), information collected from business functions such as chief risk operators/officers (CRO), and/or information collected from audit results. In some examples, input from each representative is aggregated and compared to identify a subset of the entire list of selected instances of operational risk. The subset may be limited to those factors that have been selected by more than representative, thus corroborating the importance of those factors. The system may store the list of instances of operational risk for scrutiny in subsequent stages of the operational risk decision-making process.

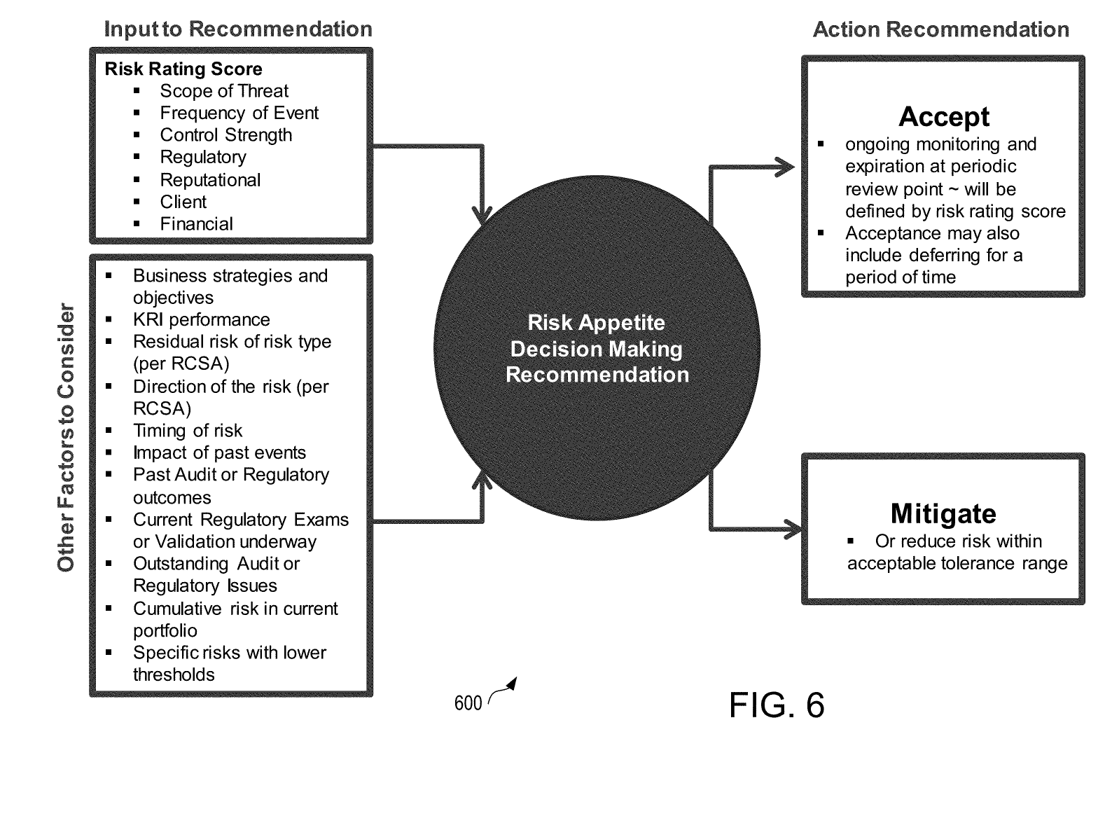

Referring again to FIG. 3, after the initial stages of the operational risk decision-making process, in the rate 306 stage, some or all of the instances of operational risk in the generated list may be quantified and/or prioritized using an operational risk rating methodology. The operational risk rating (ORR) methodology may include assessing each of the instances of operational risk against a plurality of risk rating input categories. In one embodiment, the OOR may comprise seven risk rating input categories: scope of threat, frequency of event, control strength, regulatory, reputational, client, and financial risk rating input categories. A person having ordinary skill in the art, after review of the entirety disclosed herein, will appreciate that this disclosure contemplates more or less risk rating input categories for use with the ORR methodology disclosed herein. For example, as illustrated in FIG. 6, other risk rating input categories for use with an OOR methodology 600 may include, but are not limited to, business strategies & objective, KRI (key risk indicators) performance, residual risk of risk type (per RSCA), direction of the risk (per RSCA), timing of risk, impact of past events, past audit/regulatory outcomes, current regulatory exams/validations underway, outstanding audit/regulatory issues, cumulative risk in current portfolio, specific risks with lower thresholds, and other factors.

Moreover, the risk rating input categories may be grouped into a plurality of super-categories, including, but not limited to magnitude of loss (e.g., scale/impact), and frequency of loss (e.g., probability). For example, the scope of threat, frequency of event, and control strength risk rating input categories may be grouped into a super-category of frequency of loss. And, the regulatory, reputational, client, and financial risk rating input categories may be grouped into a super-category of magnitude of loss. A person having ordinary skill in the art, after review of the entirety disclosed herein, will appreciate that this disclosure contemplates other super-categories and/or different groupings of risk rating input categories to create the aforementioned super-categories.

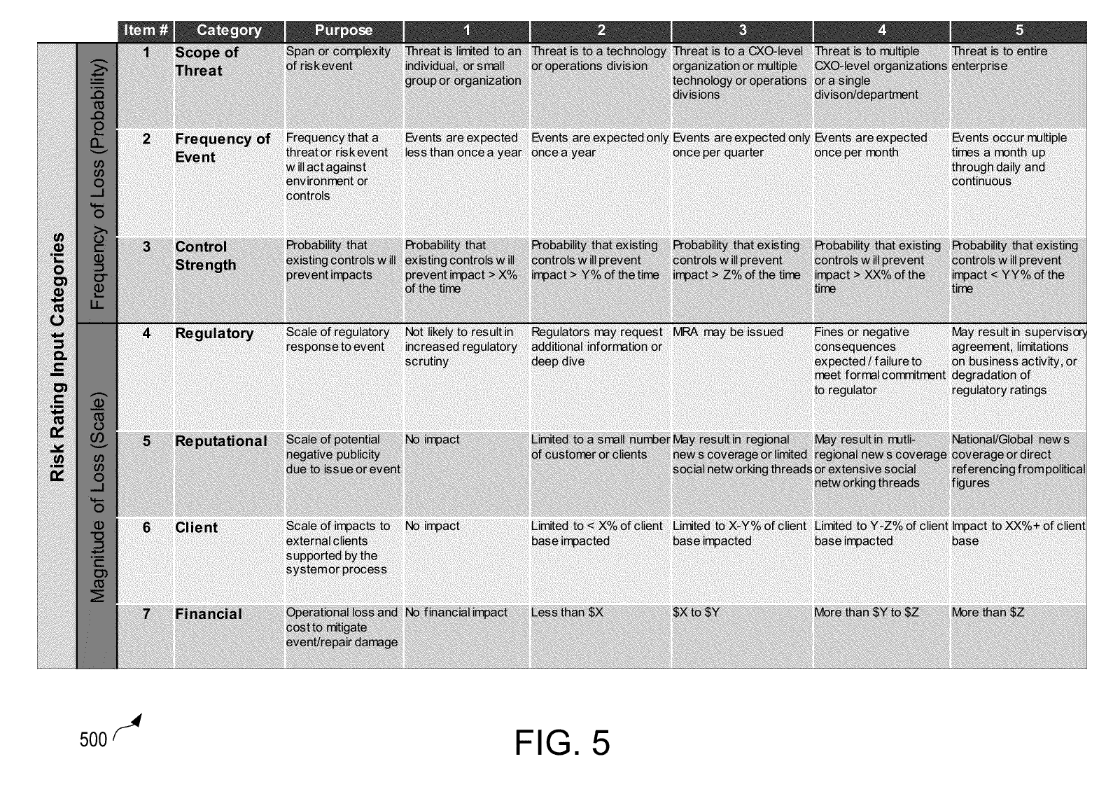

Referring to FIG. 3, in the rate 306 stage, for each instance of operational risk in the list of factors stored in computer memory 115 in the system, a user may manually provide a rating value to each risk rating input category using, for example, a rating module. The rating module may be configured to assist users in providing rating values. For example, for instance of operational risk “A”, the user may provide a rating value of 2 for the “scope of threat” risk rating input category, a rating value of 2 for the “frequency of event” risk rating input category, a rating value of 3 for the “control strength” risk rating input category, and a rating value of 1 for each of the “regulatory,” “reputational,” “client,” and “financial” risk rating input categories. A person having ordinary skill in the art, after review of the entirety disclosed herein, will appreciate that although the rating values in FIG. 5 range from “1” to “5”, the disclosure contemplates other embodiments with varying ranges, such as, ranging from “0” to “10”, or a negative value to a zero or positive value, any integer values, any decimal values, alphabetic values (e.g., A to Z), alpha-numeric values, string values (e.g., “low,” “medium”, and “high” ratings), or other values.

In the preceding example, the user may reference a chart/matrix 500, such as FIG. 5, to assess the appropriate rating value to assign to each of the risk rating input categories for a particular instance of operational risk. Such a chart/matrix may assist in consistent implementation of an operational risk rating (ORR) methodology. The system 101 may collect, record, and organize rating values provided by a user. Some examples of users of the system include, but are not limited to, risk owners, risk managers, compliance partners, audit partners, employees or vendors associated with a control function of the organization/department, and/or other people. The system may record the input data into a database 121 comprising tables with rows and columns. Alternatively, the input date may be stored in an object-oriented database or other form of data store. This disclosure presupposes that a user of the system inputting rating values will already possess the level of skill required to assess various instances of operational risk against each of the risk rating input categories configured in the system, with the aid of a chart/matrix such as FIG. 5.

In some embodiments in accordance with various aspects of the disclosure, the system 101 may permit more than one user (e.g., users operating computing devices 141, 151) to input (e.g., simultaneously/concurrently input, or serially input) rating values into the system. In such a collaborative system, a first user and a second user may provide a the system 101 with risk rating values for the same or different risk input categories of instances of operational risk. Using inter alia a collaboration module, the system may compare the competing rating values to determine whether or not there is a conflicting rating value that should be flagged for further scrutiny. The determination of whether or not there is a conflict may be based, in one embodiment, on a predetermined threshold variance. For example, a first user's rating value of 2and a second user's rating value of 3has a variance of 1. Assuming for this example that the predetermined threshold variance is set at 2.6, then the different inputted rating values might not trigger a conflict; rather, the average of the two scores may be used as the final rating value. In another example, the final rating value may be a function of the two inputted rating values taking into further consideration the status of the user inputting the value (e.g., an executive-level user's inputted value may be allocated greater weight over that of a user with a lower rank.) The aforementioned collaborative feature of the system may result in positive productivity/efficiency gains for the users. For example, rather than spending numerous hours discussing each risk rating input categories for every instance of operational risk, users can, at their own leisure, submit risk rating values to the system so that the inputted values can be compared/examined by the collaboration module, and only those that have conflicts among users may be flagged for further discussion. As such, the list of instances of operational risk the users must collectively debate/discuss may be favorably reduced.

Once the rating values are input and finalized, the system 101 may calculate an operational risk score for each instance of operational risk using, inter alia, a risk score calculation module. The risk score calculation module may be configured to calculate operational risk scores for each individual instance of operational risk factor and/or each portfolio of factors. In one embodiment, the operational risk score may be computed by: (1) summing the risk rating values of all risk rating input categories belonging to the “frequency of loss” super-category, and applying (e.g., multiplying by) a predetermined weighting factor; (2) summing the risk rating values of all risk rating input categories belonging to the “magnitude of loss” super-category, and applying (e.g., multiplying by) another predetermined weighting factor; and (3) adding the values from (1) and (2). In one example, the predetermined weighting factor may be a value of 1, 1.33, 1.5, 2, 2.33, 2.5, 3, 3.33, 3.5, 4, or other integer or decimal value. For example, in one embodiment the operational risk score may be a value between 20 to 100, where the predetermined weighting factor applied to the “frequency of loss” super-category is a 3.33 and the predetermined weighting factor applied to the “magnitude of loss” super-category is a 2.5. In such an embodiment, the operational risk score may be considered a very high priority risk when the computation of the operational risk score results in a score between 80 to 100, and a high priority risk when the score is between 60 to 80, and a medium priority risk when the score is between 40 to 60, and a low priority risk when the score is less than 40. In yet another example, the operational risk score may be a value between 20 to 100, where the predetermined weighting factor applied to the “frequency of loss” super-category is a 2.5 and the predetermined weighting factor applied to the “magnitude of loss” super-category is a 3.5. In another example, the operational risk score may be a value between 20 to 100, where the predetermined weighting factor applied to the “frequency of loss” super-category is a 1 and the predetermined weighting factor applied to the “magnitude of loss” super-category is a 1. Of course a person having ordinary skill in the art, after review of the entirety disclosed herein, will recognize that the foregoing is just one example and the disclosure contemplates variations in the aforementioned algorithm for calculating operational risk score. For example, the algorithm may include more or less super-categories than described above, and the predetermined weighting values applied may be different.

The operational risk score may, inter alia, provide an organization or department with perspective into prioritization of the risk and escalation point. The system 101 may calculate, using a processor 103, an individual operational risk score for each instance of operational risk. Referring again to FIG. 3, in the “recommend action” 308 stage of the operational risk decision-making process, the system may assist an organization/department in escalating a high-priority instance of operational risk (e.g., risk scores exceeding 60) to the appropriate user/users to determine whether to accept or mitigate the risk. In one embodiment, particular instances of operational risk may be associated with a specific user, and calculation, by the system, of an operational risk score exceeding a predetermined threshold value (e.g., high-priority value or above) may trigger the system to alert the user. The alert may be in the form of an appropriately-colored (e.g., red to indicate that it requires attention) cell in a risk decision-making matrix/chart, a generated e-mail to the user, a SMS message to the user, or other form of communication with the user. The system 101 may include a risk decision-making matrix generation module configured to generate a matrix/chart (or other similar format) for displaying a visual representation of the calculated risk scores. The user may then, referring to FIG. 6, choose to accept or mitigate the identified operational risk.

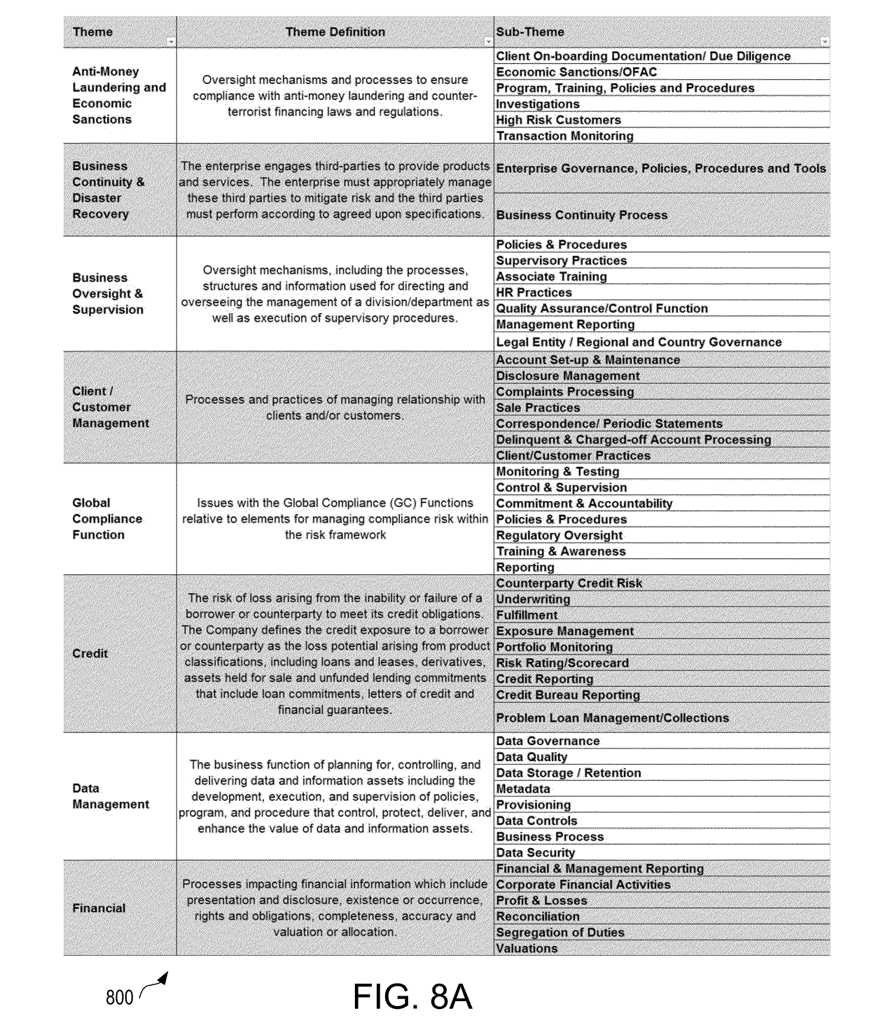

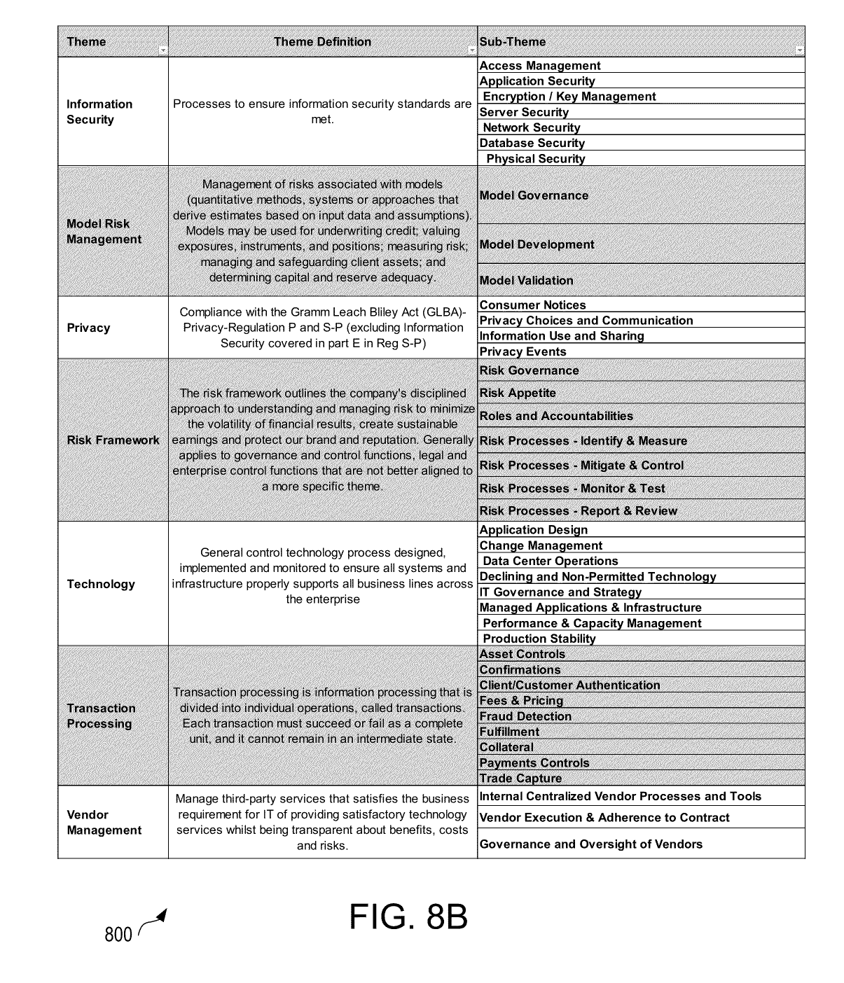

Referring to FIG. 3, in the “disposition individual risk & review portfolio exposure” 310 stage, in addition to calculating individual operational risk scores for instances of operational risk, the system 101 may calculate an aggregated operational risk score for each portfolio of related instances of operational risk. Some examples of aggregated/portfolio operational risk categories include, but are not limited to, anti-money laundering & economic sanctions, business continuity & disaster recovery, business oversight & supervision, client/customer/user management, global compliance function, credit, data management, financial, information security, model risk management, privacy, risk framework, technology, transaction processing, vendor management, and other portfolios of related instances of operational risk. The portfolios of related instances of operational risk comprise a plurality of related instances of operational risk. FIG. 8 (i.e., FIGS. 8A-8B) illustrates some of the instances of operational risk that may together comprise the respective portfolios 800. The portfolio/aggregated approach may assist in deploying a systemic response to operational risks and coordinate funding for remediation efforts. A person having ordinary skill in the art, after review of the entirety disclosed herein, will recognize that the disclosure contemplates other portfolios of aggregated instances of operational risk and those other portfolios are considered disclosed herein.

The aggregated operational risk score for a portfolio of related instances of operational risk may be graphically illustrated as an operational risk matrix/map. Such an operational risk matrix/map may illustrate the relative importance of various instances of operational risk to the organization/department and can provide focus for a user's risk management agenda. The aggregated operational risk score may highlight interrelationships between operational risks across the organization/department. Concentrations and/or correlations may be identified using this aggregated/portfolio perspective.

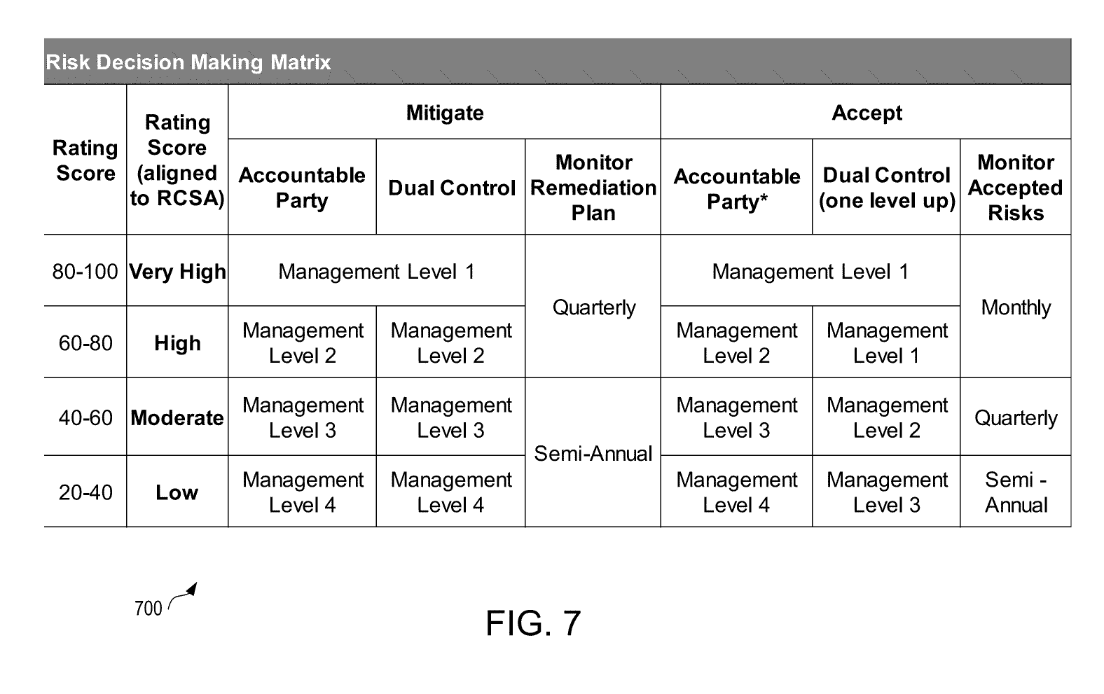

In the “disposition individual risk & review portfolio exposure” stage of the operational risk decision-making process, the calculated operational risk scores, both individual and aggregated/portfolio, may be used to escalate all unacceptable risks to the appropriate user/users. FIG. 7 illustrates a risk decision making matrix 700 to assist the system 101 in determining which user/users to alert when individual or aggregate/portfolio risk levels are above predetermined threshold values. The “accountable party” in the matrix identifies those users at different management levels that may be alerted when an operational risk score exceeds different tiered thresholds. In addition, the “monitor mediation plan” cells in the matrix identify the frequency with which the individual instances of operational risk or portfolio of related instances of operational risk may require revisiting by the user/users. The system 101 comprising a monitor module may be configured to automatically alert the appropriate user/users at the next interval for re-assessing the particular instances of operational risk. The monitor module may be configured to monitor particular instances of operational risk from among the list of instances of operational risk at regular intervals to re-assess the risk score. As explained above, alerts may be in the form of e-mail, SMS, and other forms of communication. This stage of re-assessing particular instances of operational risk may coincide with the “monitor” (quality assurance monitor) 312 stage of the operational risk decision-making process.

In one embodiment in accordance with various aspect of the disclosure, the system 101 may generate a graphical user interface (GUI) to visually display instances of operational risk, and corresponding operational risk scores in an individual view and aggregated operational risk scores in a portfolio view. The GUI may comprise a cumulative risk aggregation by department/division and risk type to provide a perspective of total risk exposure and insights into opportunities for risk acceptance/mitigation refinement. In some embodiments, the GUI may also comprise a cumulative portion to display a portfolio view of all risk accepted/mitigated by management level by operational risk type.

In another embodiment, the GUI generated by a processor 103 of the system 101 may include a drill-down feature to allow a user to view operational risk at an individual instance of operational risk level, and then in an aggregated portfolio view. The processor 103 may access a data store (e.g., database 121) to retrieve stored rating values for each of the risk rating input categories for an instance of operational risk. In some instances, as described above, where an automated collaboration feature of the system is used, the GUI may display more than one rating value in a particular cell and, if appropriate, flag (e.g., highlight) the cell to indicate a conflict exceeding predetermined variance thresholds. Such a GUI may be used by a group of users to identify and discuss/debate those inputted rating values that differ among the users. At least one advantage of the aforementioned feature is a focused analysis and discussion around those operational risks.

In accordance with various aspect of the disclosure, a processor 103 of the system 101 may be located in a web application server that receives a plurality of inputs from various user workstations 141, 151. With regards to the corroboration feature described above, the server may allow more than one rating value to be associated with a single cell. Unlike a spreadsheet, which conventionally only permits one value to be stored in a cell, the server may be implemented with computer-executable instructions, in accordance with the process steps described herein, stored on computer memory. The instructions may permit collection of more than one rating value and then a comparison of those plurality of rating values to determine which value (or new value-e.g., an average of the plurality of values) to use as the final rating value.

In addition, the system 101 may generate a reporting message (e.g., a monthly reporting e-mail, a weekly static webpage update, a real-time dynamic HTML webpage update, or other forms of communication) in the “reporting and review in RCSA (risk and control self-assessment) attestation” 314 stage of FIG. 3. The reporting message may comprise an operational risk matrix/map that management level users (e.g., management level 3, 2, and 1 in FIG. 7) may use to identify, escalate, and debate instances of operational risk. The reporting message may include one or more of the features disclosed herein, including, but not limited to aggregation/portfolio reporting.

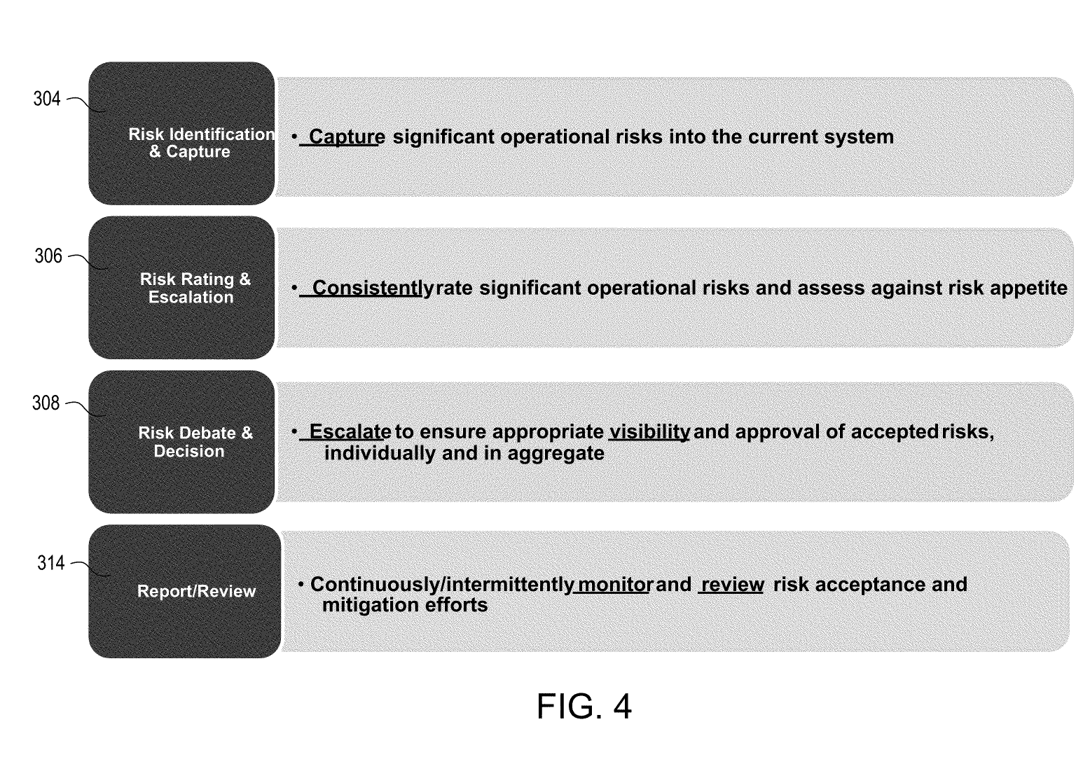

While the aspects described herein have been discussed with respect to specific examples including various modes of carrying out aspects of the disclosure, those skilled in the art will appreciate that there are numerous variations and permutations of the above described systems and techniques that fall within the spirit and scope of the disclosure. Moreover, reference is made to accompanying figures, which form a part hereof, to illustrate various embodiments of the disclosure, it is to be understood that other embodiments may be utilized that are not expressly illustrated in the figures. Moreover, one or more steps or stages illustrated in the figures may be optional or omitted. For example, in some embodiments, the identify and capture stages (302 and 304) in FIG. 3 may be conflated into a single stage (e.g., see FIG. 4), and the later stages may be conflated into one or more stages; the spirit of the disclosure is not so limited to just those stages illustrated in the figures.

In accordance with various aspect of the disclosure, a method is disclosed herein for calculating a quantitative operational risk score for an organization. The method comprises: identifying a plurality of instances of operational risk relevant to the organization to scrutinize; storing, by a processor, in computer memory the list of instances of operational risk; for each instance of operational risk, providing a rating value for each risk rating input category; storing, by the processor, the rating values in the computer memory; calculate, by the processor, an operational risk score for each instance of operational risk in the list; generate and display, by the processor, a risk decision-making matrix/chart; calculate, by the processor, a portfolio/aggregated operational risk score for each portfolio of related instances of operational risk; generate and display, by the processor, a risk decision-making matrix/chart for the portfolio scores; discuss and escalate the instance of operational risk for mitigation or acceptance; and monitor particular instances of operational risk from among the list of instances of operational risk at regular intervals to re-assess the risk score. A person having ordinary skill in the art will recognize after view of the entirety disclose herein that one or more method steps may be omitted or optional, and additional steps or sub-steps are contemplated. Furthermore, disclosed herein is a non-transitory, tangible computer-readable medium storing computer-executable instructions, that when executed by a processor of the system, cause the system to perform the aforementioned method. In some embodiments, the computer-executable instructions may be embodied as modules or components executable by the processor. Some examples of such modules include, but are not limited to, an identification module configured to assist users in selecting a plurality of instances of operational risk from a larger list of possible instances of operational risk and (optionally) storing the selections in computer memory; a rating module configured to assist users in providing rating values; a collaboration module configured to provide the system with the collaboration features described above; a risk score calculation module configured to calculate operational risk scores for each individual instance of operational risk factor and each portfolio of factors; a risk decision-making matrix generation module configured to generate a matrix/chart (or other similar format) for displaying a visual representation of the calculated risk scores; and a monitor module to monitor particular instances of operational risk from among the list of instances of operational risk at regular intervals to re-assess the risk score.

We claim:

1. An apparatus configured to assist in operational risk decision-making, comprising:
at least one processor coupled to at least one computer memory and configured to execute a plurality of modules stored in the memory; and
the at least one memory storing the plurality of modules comprising:
an identification module configured to select a plurality of instances of operational risk and store the selections in memory;
a rating module configured to receive rating values;
a risk score calculation module configured to calculate operational risk scores for individual instances of operational risk and portfolio of risks;
a risk decision-making matrix generation module configured to generate a visual representation including the calculated risk scores; and
a monitor module to monitor particular instances of operational risk from among the instances of operational risk at regular intervals to re-assess the operational risk score.

2. The apparatus of claim 1, wherein the risk score calculation module is further configured to:
sum risk rating values of risk rating input categories of a frequency of loss type;
multiply the frequency of loss sum by a first predetermined weighting factor to calculate a first result;
sum risk rating values of risk rating input categories of a magnitude of loss type;
multiply the magnitude of loss sum by a second, different predetermined weighting factor to calculate a second result; and
sum the first result and the second result to generate the operational risk score.

3. The apparatus of claim 2, wherein the frequency of loss type comprises risk rating input categories of scope of threat, frequency of event, and control strength.

4. The apparatus of claim 2, wherein the magnitude of loss type comprises risk rating input categories of regulatory, reputational, client, and financial.

5. The apparatus of claim 2, wherein the first predetermined weighting factor is one of 2.5, 3, 3.33, and 3.5, and the second predetermined weighting factor is one of 2.5, 3, 3.33, and 3.5.

6. The apparatus of claim 1, wherein the risk score calculation module is further configured to calculate an aggregated operational risk score for a portfolio of operational risks, wherein the aggregated operational risk score is for at least one of anti-money laundering and economic sanctions, business continuity and disaster recovery, business oversight and supervision, and vendor management.

7. The apparatus of claim 1, wherein the risk decision-making matrix generation module is further configured to generate a decision-making matrix for the aggregated operational risk score for the portfolio, wherein a cell in the decision-making matrix uses a color to indicate an alert requiring attention, and wherein the portfolio decision-making matrix highlights interrelationships between operational risks across an organization.

8. The apparatus of claim 1, wherein the visual representation comprises at least one of a chart or matrix that assists in determining which user to alert when the risk score is above a predetermined threshold value.

9. The apparatus of claim 1, wherein the monitor module may alert a user to select one of operational risk acceptance and operational risk mitigation with respect to an instance of operational risk.

10. The apparatus of claim 1, wherein the at least one memory further stores a collaboration module configured to allow more than one rating values to be associated with a single cell in the decision-making matrix, and to compare the more than one rating values to determine a final rating value to be associated with the single cell.

11. A method for calculating a quantitative operational risk score for an organization, comprising:
identifying a plurality of instances of operational risk relevant to the organization;
storing, by a computer processor, the plurality of instances of operational risk in computer memory;
for each instance of operational risk, receiving a rating value for each risk rating input category;
storing, by the processor, the rating values in the memory;
calculating, by the processor, an operational risk score for each instance of operational risk;
generating, by the processor, a risk decision-making matrix including the calculated operational risk scores;
outputting, by the processor, a risk appetite decision-making recommendation with respect to the instance of operational risk comprising one of a recommendation to accept risk and a recommendation to mitigation risk; and
monitoring, by the processor, the plurality of instances of operational risk at a predetermined intervals to re-assess the operational risk score for each instance of operational risk.

12. The method of claim 11, further comprising:
calculating, by the processor, an aggregated operational risk score for a portfolio of related instances of operational risk;
generating, by the processor, the risk decision-making matrix including the calculated aggregated operational risk score; and
outputting, by the processor, a risk appetite decision-making recommendation with respect to the portfolio of related instances of operational risk comprising one of a recommendation to accept risk and a recommendation to mitigation risk.

13. The method of claim 12, wherein the aggregated operational risk score is for at least one of anti-money laundering and economic sanctions, business continuity and disaster recovery, business oversight and supervision, and vendor management, and wherein a cell in the decision-making matrix uses a color to indicate an alert requiring attention.

14. The method of claim 11, wherein the calculating of the operational risk score for each instance of operational risk comprises:
summing, by the processor, risk rating values of risk rating input categories of a frequency of loss type;
multiplying, by the processor, the frequency of loss sum by a first predetermined weighting factor to calculate a first result;
summing, by the processor, risk rating values of risk rating input categories of a magnitude of loss type;
multiplying, by the processor, the magnitude of loss sum by a second, different predetermined weighting factor to calculate a second result; and
summing, by the processor, the first result and the second result to generate the operational risk score.

15. The method of claim 14, wherein the frequency of loss type comprises risk rating input categories of scope of threat, frequency of event, and control strength; and wherein the magnitude of loss type comprises risk rating input categories of regulatory, reputational, client, and financial.

16. The method of claim 14, wherein the first predetermined weighting factor is one of 2.5, 3, 3.33, and 3.5, and the second predetermined weighting factor is one of 2.5, 3, 3.33, and 3.5.

17. The method of claim 11 including a collaboration feature, wherein the method further comprising:
associating more than one rating values with a single cell in the risk decision-making matrix;
comparing the more than one rating values to determine a final rating value to be associated with the single cell.

18. A non-transitory, tangible computer-readable medium storing computer-executable instructions, that when executed by a computer processor, cause an operational risk decision-making system to execute steps comprising:
selecting a plurality of instances of operational risk;
storing the selections of instances of operational risk;
receiving rating values for the instances of operational risk;
calculating operational risk scores for individual instances of operational risk and portfolio of risks;
generating a visual representation including the calculated risk scores; and
monitoring particular instances of operational risk from among the instances of operational risk at a predetermined intervals to re-assess the operational risk score.

19. The non-transitory, tangible computer-readable medium of claim 18, storing computer-executable instructions, that when executed by the computer processor, cause the operational risk decision-making system to execute steps further comprising:
summing risk rating values of risk rating input categories of a frequency of loss type;
multiplying the frequency of loss sum by a first predetermined weighting factor to calculate a first result;
summing risk rating values of risk rating input categories of a magnitude of loss type;
multiplying the magnitude of loss sum by a second, different predetermined weighting factor to calculate a second result; and
summing the first result and the second result to generate the operational risk score,
wherein the frequency of loss type comprises risk rating input categories of scope of threat, frequency of event, and control strength, and wherein the magnitude of loss type comprises risk rating input categories of regulatory, reputational, client, and financial, and wherein the first predetermined weighting factor is one of 2.5, 3, 3.33, and 3.5, and the second predetermined weighting factor is one of 2.5, 3, 3.33, and 3.5.

20. The non-transitory, tangible computer-readable medium of claim 18, storing computer-executable instructions, that when executed by the computer processor, cause the operational risk decision-making system to execute steps further comprising:
calculating an aggregated operational risk score for a portfolio of operational risks, wherein the aggregated operational risk score is for at least one of anti-money laundering and economic sanctions, business continuity and disaster recovery, business oversight and supervision, and vendor management; and
generating a decision-making matrix for the aggregated operational risk score for the portfolio, wherein a cell in the decision-making matrix uses a color to indicate an alert requiring attention.
